(19) United States
(12) Patent Application Publication
(10) Pub. No.: US 2003/0001380 A1
(43) Pub. Date: Jan. 2, 2003

(54) Multi-purpose business form for invoicing, for payment of invoice, for reorder, for shipping, for remittance of payment and for even stacking of the form

(76) Inventor: Gary E. Stewart, Phoenix, AZ (US)

Correspondence Address: Tod R. Nissle, Esq., TOD R. NISSLE, P.C., P.O. Box 55630, Phoenix, AZ, 85078, US

(21) Appl. No.: 09/896,756

(22) Filed: Jun. 29, 2001

(51) Int. Cl. B42D 15/00

(52) U.S. Cl. 283/60.1

(57) ABSTRACT

A method and apparatus forms stacks of paper sheets. The sheets each have areas of different thickness. The sheets also include lines of prominence formed in thinner areas of the sheets. The lines of prominence function to increase the thickness of the thinner areas of each so the sheets stack evenly.

This invention relates to business forms.

More particularly, the invention relates to business forms having die cut label areas and areas separable from the form along lines of weakening.

In a further respect, the invention relates to a business form which can be utilized by a vendor to mail an invoice to a customer, can be used by the customer to pay the invoice, and can be used by the customer to reorder goods from the vendor.

In still another respect, the invention relates to a method and apparatus for forming stacks of business forms which are level and which do not tilt because of labels, backings, or other materials which are attached only to a portion of the business form.

Business forms with address labels which can be peeled from the form are well known, as are business forms with lines of perforation which permit the forms to be torn along the lines of weakening.

One function of a business form is to provide a mailing label which can used to address a package containing the business form.

Another function of a business form is to provide an invoice which a customer can pay on receipt of the business form.

A further function of a business form is to provide a means for reordering goods provided by a vendor.

Still another function of a business form is to provide a means for mailing a payment or order to a vendor.

A single business form which functions to fulfill each of the functions noted above apparently has not been provided.

Another problem associated with business forms and other sheets of materials which are stacked is the formation of stacks which tilt to one side or another. The sheets tilt because labels or other materials are applied to only a portion of the sheet, making that portion of the sheet thicker. When a plurality of such sheets are stacked, the portion of the stack including the thicker portion of each sheet is higher than the portion of the stack which does not include the thicker portion of each sheet. As a result, the stack tilts. Tilting of the stack of sheets is undesirable because it adversely affects the ease with which the sheets feed into a printer, perforator, or other piece of processing equipment. When the stack of sheets tilts, it is more likely that one of the sheets will jam in the feeder on the piece of equipment being used to process the sheets.

Accordingly, it would be highly desirable to provide an improved multi-purpose unitary business form which would provide an invoice, a mailing label, means for paying the invoice, and means for reordering product from a vendor.

It would also be highly desirable to provide an improved method and apparatus for processing sheets of paper or other material which are not of uniform thickness and which tend to form a stack which tilts.

Therefore, it is a principal object of the instant invention to provide an improved business form.

Another object of the invention is to provide an improved method for providing and using a business form to invoice and mail a customer and for the customer to pay the invoice and to reorder product from a vendor.

A further object of the invention is to provide an improved method and apparatus for stacking sheets which each have an equivalent shape, contour, and dimension, and which each have portions that are thicker than other portions of the sheet.

Still another object of the invention is to provide an improved method and apparatus for stacking sheets of non-uniform thickness in a level stack such that each sheet in the stack generally lies in a flat plane parallel to the other sheets in the stack.

The foregoing and other, further and more specific objects and advantages of the invention will be apparent from the following detailed description of the invention, taken in conjunction with the drawings, in which:

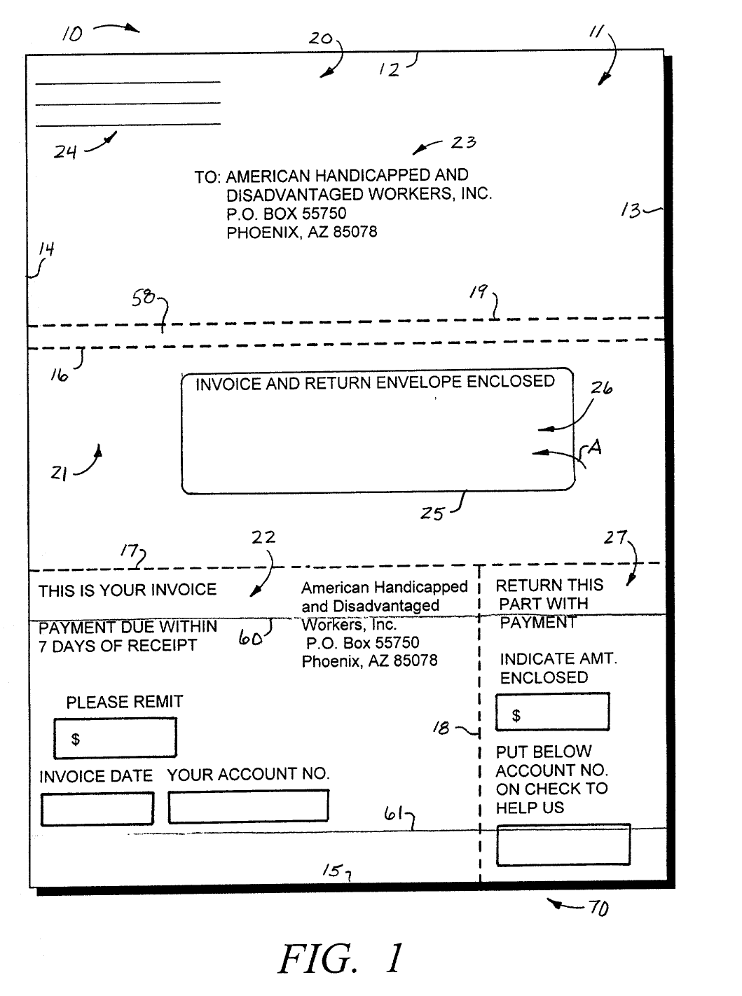

FIG. 1 is a top view illustrating a business form constructed in accordance with the principles of the invention;

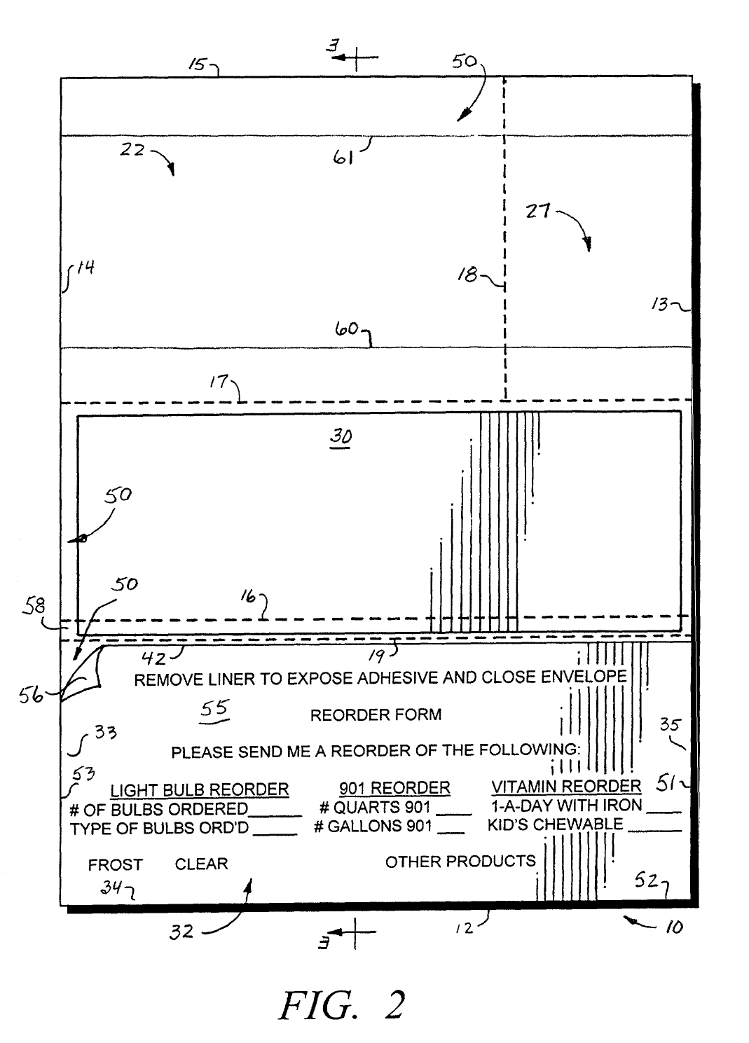

FIG. 2 is a back view further illustrating construction details of the business form of FIG. 1;

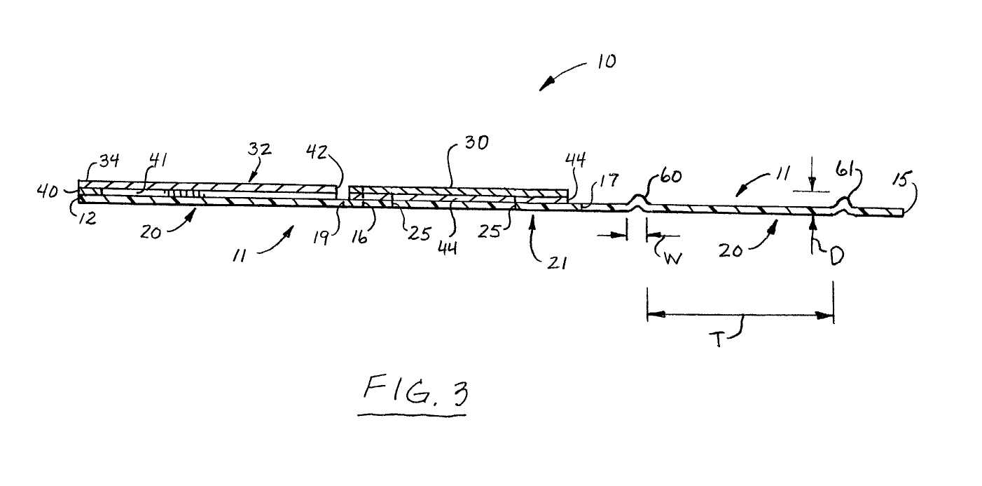

FIG. 3 is a section view of the business form of FIG. 2 taken along section line 3-3 thereof and further illustrating construction details thereof;

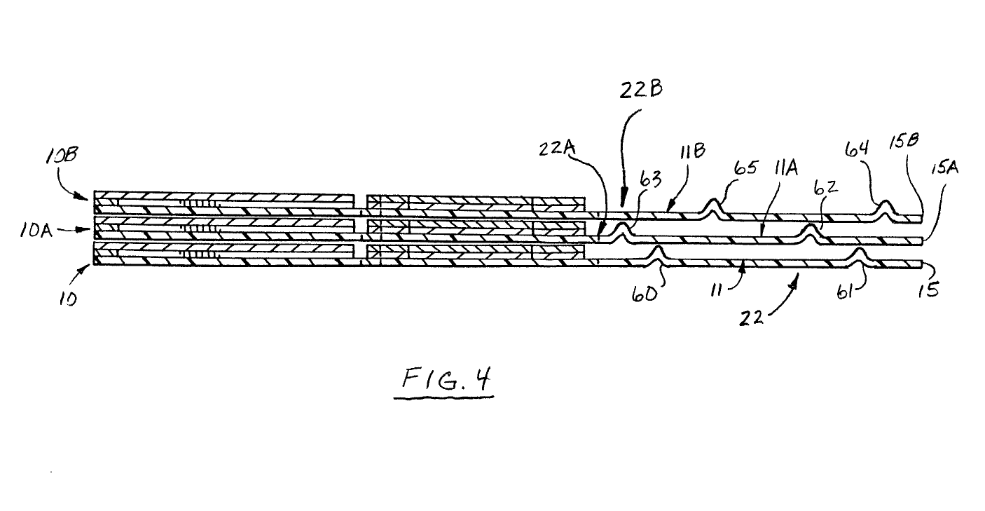

FIG. 4 is a section view of a stack of business forms illustrating how lines of prominence formed in the business forms facilitate the formation of a level stack of forms;

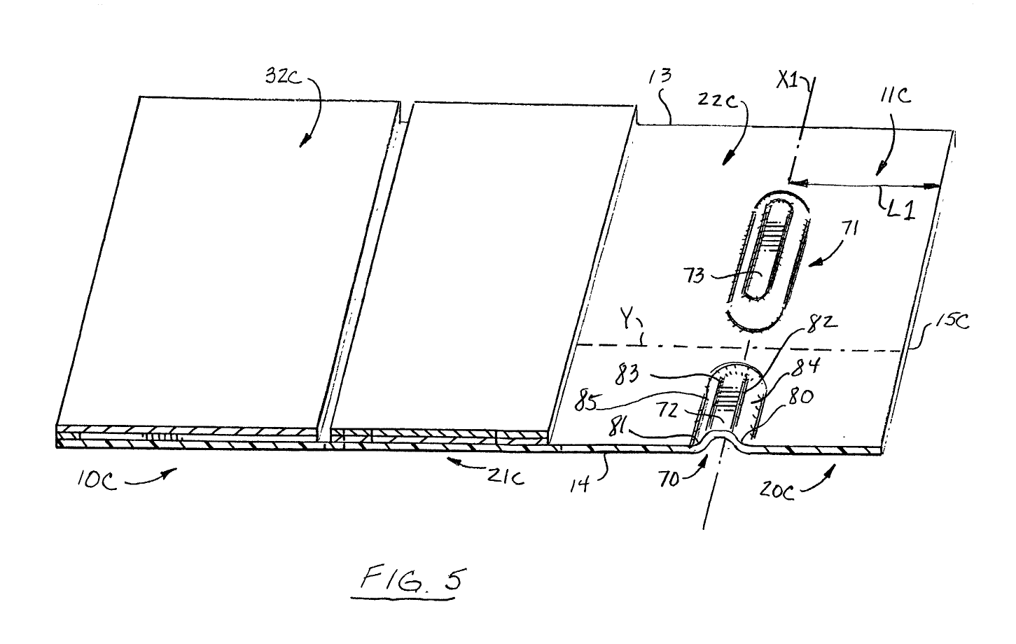

FIG. 5 is a perspective view of a business form identical to the form of FIG. 2 except for lines of prominence formed therein; and,

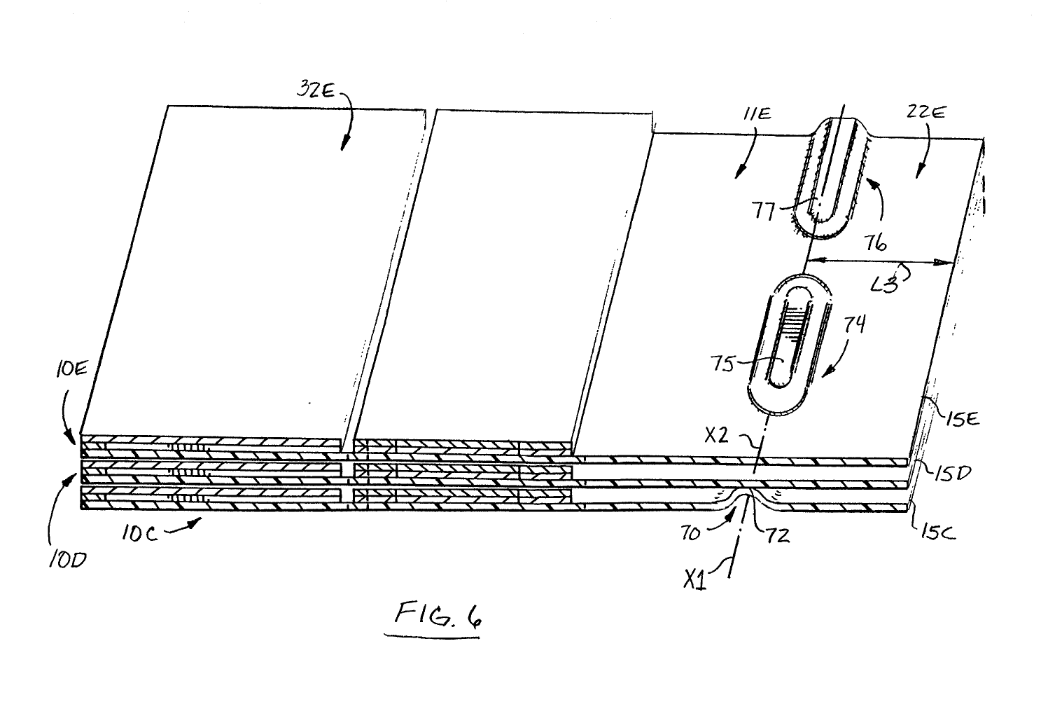

FIG. 6 is a section view of a stack of business forms illustrating how lines of prominence formed in the business forms facilitate the formation of a level stack of forms.

Briefly, in accordance with the invention, I provide an improved business form comprising a first leaf having a front side, a back side, a width, a height, an outer peripheral edge; spaced apart first and second lines of weakening dividing the leaf into first, second, and third sections; an imprinted die cut area lying in the second section within the outer peripheral edge; a mailing label formed on the front side in the die cut area; an envelope address imprinted on the front side in the first section; an invoice imprinted on the front side in the third section; a sheet of material attached along three sides to the first section on the back side such that the sheet of material and the first section form an envelope; a third line of weakening in the first section forming a flap for the envelope; and, a sheet of liner material attached to portions of the first and second sections on the back side, the liner material extending over the flap of the envelope and including an adhesive layer which separates from the liner and adheres to the die cut area and the flap of the envelope.

In a further embodiment of the invention, I provide an improved business form comprising a first leaf having a front side, a back side, a width, a height, and an outer peripheral edge; spaced apart first and second lines of weakening dividing the leaf into first, second and third sections; an imprinted die cut area lying in the second section within the outer peripheral edge; a mailing label formed on the front side in the die cut area; an envelope address imprinted on the front side in the first section; an invoice imprinted on the front side in the third section; a sheet of material attached along three sides to the first section on the back side such that the sheet of material and the first section form an envelope; a third line of weakening in the first section forming a flap for the envelope; and, a sheet of liner material attached to portions of the first and second sections on the back side, the liner material extending over the flap of the envelope and including an adhesive layer which separates from the liner and adheres to the die cut area and the flap of the envelope. The business form also includes at least one line of prominence extending outwardly from the front side of the third section.

In another embodiment of the invention, I provide a plurality of sheets of material of equivalent size. Each of the sheets has a plurality of lines of prominence. The lines of prominence for one of the sheets are at different locations on the sheet than are the lines of prominence on the remaining sheets.

Turning now to the drawings, which depict the presently preferred embodiment of the invention for the purpose of illustrating the practice thereof and not by way of limitation of the scope of the invention, and in which like reference characters refer to corresponding elements throughout the several views, FIG. 1 illustrates the front of a business form constructed in accordance with the invention. Form 10 includes a rectangular face 11 extending between peripheral edges 12, 13, 14, 15. Lines of weakening 16, 17 divide form 10 into rectangular sections 20, 21, 22. Section 21 is intermediate sections 20 and 22.

Section 23 includes an envelope mailing address 23 imprinted or otherwise formed on face 11 and includes return address block 24 formed on face 11.

Section 21 includes a mailing label 26 circumscribed by die-cut line 25. Label 26 is peeled off in the direction of arrow A. The words “INVOICE AND RETURN ENVELOPE ENCLOSED” are imprinted or otherwise formed on face 11 on the face of label 26. A mailing address can be imprinted on the face of label 26. When label 26 is peeled off, adhesive adheres to the back of label 26 and is used to fasten label 26 to an envelope or package.

Section 22 includes an invoice imprinted or formed on face 11 and on the face of section 22. The invoice includes the words “THIS IS YOUR INVOICE”, “PAYMENT DUE WITHIN 7 DAYS OF RECEIPT”, “PLEASE REMIT”, “INVOICE DATE”, “YOUR ACCOUNT NO.”, and the address of American Handicapped and Disadvantaged Workers, Inc.

Section 22 also include a payment stub 27 imprinted or formed on face 11 and on the face of stub 27. The payment stub includes the words “RETURN THIS PART WITH PAYMENT”, “INDICATE AMOUNT ENCLOSED”, and “PUT BELOW ACCOUNT NO ON CHECK TO HELP US”.

FIG. 2 illustrates the back of business form 10 constructed in accordance with the invention. Form 10 includes a rectangular back surface 50 extending between peripheral edges 12, 13, 14, 15.

Rectangular sheet of material 32 includes peripheral edges 42, 51, 52, 53. Edge 51 lies along a portion of edge 13. Edge 51 lies along a portion of edge 12. Edge 53 lies along a portion of edge 14. A reorder form is imprinted or otherwise formed on the face 55 of sheet 32. The portions of back surface 56 of sheet 32 which are beneath peripheral portions 33, 34, 35 are adhered to back surface 50 by adhesive 40 such that sheet 32 and section 20 form an envelope. Since the portion of surface 56 beneath edge 19 is not adhered to surface 50, a piece of paper can be slid past edge 19 and between section 20 and sheet 32 into the envelope. The envelope is detached from business form 10 along line of weakening 16. Backing 30 is peeled off to expose adhesive 44 on the portion of surface 50 on envelope flap 58.

Business form 10 includes salient lines of prominence 60 and 61 formed in the section 22 of form 10. These lines of prominence 60, 61 protrude and extend outwardly from the generally flat planar surface defined by section 22 and by the front surface of section 22. The purpose of lines of prominence 60 and 61 is, when business forms are stacked, to give section 22 a thickness which is closer to or is about equivalent to the increased thickness in the other sections of form 10 which results when backing 30, sheet 32, adhesive 40 and adhesive 44 are applied to selected portions of form 10.

Lines of prominence 60 and 61 can extend any desired distance D above section 22 (FIG. 3). In many instances, however, the distance D is typically in the range of one to three thousandths of an inch. The width W can vary as desired. The distance T between lines of prominence can vary as desired, but it is presently preferred that within a distance T there are at least three lines of prominence.

Lines of prominence 60 and 61 can be formed by any desired means. Simply scoring a sheet of material along a line may form a line of prominence on the side of the sheet opposite the side on which the sheet was scored. Embossing techniques can be used to form lines of prominence. When the sheet is originally manufactured, it can be made with lines of prominence.

It is critical in the practice of the invention that at least every other sheet of material have lines of prominence formed at different places on the sheet. If each sheet of material has lines of prominence formed at the same locations on each sheet, then the lines of prominence will tend to nest one on top of the other, and the purpose of the invention will be defeated. In the practice of the invention, the lines of prominence are intended to function in the manner shown in FIG. 4 and to act as spacers which function to level out sections 22, 22A, and 22B with respect to the portions of form 10 which have increased thickness due to layers of adhesive 40 and 44, layer of material 32, and backing layer 30.

In FIG. 4, business form 10 is identical to business forms 10A and 10B. Forms 10A and 10B are stacked on top of and in registration with form 10. Consequently, edge 15A of form 10A is equivalent to edge 15 of form 10; edge 15B of form 10B is equivalent to edge 15 of form 10; sections 22A and 22B are each equivalent to section 22; and, faces 11A and 11B are equivalent to face 11.

Lines of prominence (or projections) 60 and 61 function to lift section 22A into an orientation in which section 22A is generally parallel to the remainder of form 10A. Lines of prominence 62 and 63 function to lift section 22B into an orientation in which section 22B is generally parallel to the remainder of form 10B. If another form 10C (not shown) identical to form 10B were placed on top of and in registration with form 10B, lines of prominence 64 and 65 would function to maintain the section 22C of form 10C in an orientation in which section 22C was generally parallel to the remainder of form 10B. It is important to note that the lines of prominence 60 and 61 in form 10 are formed at different locations than and are offset from the lines of prominence 62 to 64 of forms 10A and 10B and that, as a result, the lines of prominence 62 and 63 do not nest with lines of prominence 60 and 61, nor would lines of prominence 64 and 65 nest with lines of prominence 60 and 61 or with lines 62 and 63. As noted earlier, it not necessary that each sheet have lines of prominence which are located at different positions that the lines of prominence of every other sheet. In general, it is of primary importance that the lines of prominence in each adjacent pair of sheets in a stack of sheet do not nest. It is probably also advantageous, however, to have at least three or four different locations for lines of prominence so that there are in each stack at least three or four sheets where the location of the lines of prominence for each of the three or four sheets is different from the location of the lines of prominence in each of the other sheets.

In FIG. 4, the lines of prominence 60 to 64 each extend upwardly in the same direction from a section 22, 22A, 22B. The lines of prominence can, if desired, extend downwardly from a section 22, 22A, 22B. A single sheet may also, if desired, have one or more lines of prominence which extend upwardly and have one or more other lines of prominence which extend downwardly.

While it is possible to form a line of prominence in a thicker section (for example, in the section of form 10 including backing 30 of a form 10 or other sheet), the principal purpose of lines of prominence dictates that they be formed in portions of a sheet which are thinner and which ordinarily (if lines of prominence were not formed therein) would tend to cause a stack of the sheets to tilt because the thicker portions of the sheets would make one side of the stack of sheets higher than the other side of the stack formed by the thinner portions of the sheets in the stack.

In FIGS. 5 and 6, business forms 10C, 10D, and 10E are identical to business form 10 except for the location of lines of prominence formed therein. Consequently, edge 15C of form 10CA is equivalent to edge 15 of form 10; edge 15D of form 10D is equivalent to edge 15 of form 10; sections 22C, 22D, and 22E are each equivalent to section 22; and, faces 11 C, 11 D, and 11E are equivalent to face 11. In FIG. 6, forms 10C to 10E are stacked in registration with each another.

In FIG. 1, lines of prominence 60 and 61 extend continuously across the form from edge 13 to edge 14. In conjunction with this feature, the location of lines of prominence on one form 10 are, as shown in FIG. 4, offset along the form from the location of lines of prominence on another form 10B, 10C.

In contrast to the lines of prominence illustrated in FIGS. 3 and 4, the lines of prominence 70, 71, 74, 76 illustrated in FIGS. 5 and 6 do not extend continuously from edge 13 to edge 14. Instead, each line of prominence 70, 71, 74, 76 extends only a partial distance between edges 13 and 14. Further, the lines of prominence 70 and 71 for form 10C are formed along axis X1. Axis X1 is a line which is parallel to edge 15C and is a distance L1 from edge 15C.

Similarly, for form 10E (FIG. 6), axis X2 is a line which is parallel to edge 15E and is a distance L3 from edge 15E. Distance L3 equals distance L1 and the position of axis X2 on form 10E is identical to the position of axis X1 on form 10C. There is an axis X3 (not shown) for form 10D which is at a position on form 10D which is identical to the position of axis X1 on form 10C. In other words, in FIG. 6, axis X3 is directly above, is in registration with, and is generally parallel to axis X1. Axis X2 is directly above, is in registration with, and is generally parallel to axes X1 and X3. The lines of prominence formed along axis X3 on form 10D (not visible) will not nest with the lines of prominence 70 and 71 formed in form 10C along axis X1 because the lines of prominence formed in form 10 are, at least in part, laterally offset from the lines of prominence 70 and 71—in the same manner that lines of prominence 74 and 76 are laterally offset from lines of prominence 70 and 71.

One way to offset laterally—at least partially—a line of prominence 74 from a line of prominence 70 is to have the shape and dimension of line of prominence 74 be identical to the shape and dimension of line of prominence 70 and to offset or move the position of line of prominence along axis X2 so that the position of line of prominence 74 on form 10E is different from the position of line of prominence 70 on form 10C.

Another way to offset—at least partially—a line of prominence 74 from a line of prominence 70 is to make the length or width or other shape or dimension of line of prominence 74 smaller than that of line of prominence 70 such that line of prominence 70 can not nest in line of prominence 74.

An advantage of the embodiment of the invention illustrated in FIGS. 6 and 7 is that all the lines of prominence on each business form can be made along a line (or lines) which is at the same location on each business form.

In FIGS. 6 and 7, each business form has lines of prominence formed along only one axis X1, X2, X3 of each business form. As would be appreciated by those of skill in the art, lines of prominence can be formed along two or more axes on each form or piece of material. In addition, lines of prominence formed on a business form need not be parallel to axes X1, X2, X3, but can be formed along a line or axis which is normal to or at some other angle to axes X1, X2, X3.

Lines of prominence 70, 71, 74, 76 each have a flat plateau or upper surface 72, 73, 75, 77, respectively. Such flat upper surfaces 72, 73, 75, 77 facilitate the support of a business form or other sheet stacked on top of and contacting said surfaces.

The shape, contour, dimension of each line of prominence and the number of lines of prominence necessary to support in a level orientation a business form or other sheet stacked on top of the lines of prominence depends on a variety of factors including the stiffness and thickness of the stacked sheet and the strength of the lines of prominence (especially when a high stack of sheets is anticipated). A desired shape, contour, and dimension of each line of prominence, along with the number of and location of the lines of prominence, can be determined for various kinds of forms and sheets.

Another advantageous feature of the lines of prominence 70, 71, 74, and 76 is that the transition from, for example, section 22C to line of prominence 70 is accomplished by curved concave radii surfaces 80, 81 to reduce the likelihood that the form 10C will be torn during formation of line of prominence 70. Curved convex radii surfaces 82 and 83 also transition from sides 84 and 85 to flat surface 72.

In another embodiment of the invention, a line or lines of prominence are formed along an axis X1 which also functions as a line of weakening used in folding or tearing a form 10C. In this embodiment of the invention, the line or lines of prominence serve the dual function of leveling a stack of paper and of facilitating the folding or tearing of the form 10C or other sheet of material.

Having described my invention in such terms as to enable those of skill in the art to make and practice it, and having described the presently preferred embodiments thereof,

I claim:

1. A business form comprising
(a) a first leaf having a front side, a back side, a width, a height, an outer peripheral edge;
(b spaced apart first and second lines of weakening dividing said leaf into first, second and third sections;
(c) an imprinted die cut area lying in said second section within said outer peripheral edge;
(d) a mailing label formed on said front side in said die cut area;
(e) an envelope address imprinted on said front side in said first section;
(f) an invoice imprinted on said front side in said third section;
(g) a sheet of material attached along three sides to said first section on said back side such that said sheet of material and said first section form an envelope;
(h) a third line of weakening in said first section forming a flap for said envelope;
(i) a sheet of liner material attached to portions of said first and second sections on said back side, said liner material extending over said flap of said envelope and including an adhesive layer which separates from said liner and adheres to said die cut area and said flap of said envelope.

2. A business form comprising
(a) a first leaf having a front side, a back side, a width, a height, an outer peripheral edge;
(b spaced apart first and second lines of weakening dividing said leaf into first, second and third sections;
(c) an imprinted die cut area lying in said second section within said outer peripheral edge;
(d) a mailing label formed on said front side in said die cut area;
(e) an envelope address imprinted on said front side in said first section;
(f) an invoice imprinted on said front side in said third section;
(g) a sheet of material attached along three sides to said first section on said back side such that said sheet of material and said first section form an envelope;
(h) a third line of weakening in said first section forming a flap for said envelope;
(i) a sheet of liner material attached to portions of said first and second sections on said back side, said liner material extending over said flap of said envelope and including an adhesive layer which separates from said liner and adheres to said die cut area and said flap of said envelope; and, (j) at least one line of prominence extending outwardly from said front side of said third section.

3. A plurality of sheets of material of equivalent size, each of said sheets having a plurality of lines of prominence, the line of prominence for one of said sheets being at different locations than the lines of prominence of the remaining sheets.
